(19) United States
(12) Patent Application Publication
(10) Pub. No.: US 2014/0278949 A1
(43) Pub. Date: Sep. 18, 2014

(54) METHOD AND APPARATUS FOR MODIFYING INTERNET CONTENT THROUGH REDIRECTION OF CASCADING STYLE SHEET OBJECTS

(71) Applicants: Derek Stephen Maxson, Twain Harte, CA (US); Scott Kenneth Smith, Modesto, CA (US)

(72) Inventors: Derek Stephen Maxson, Twain Harte, CA (US); Scott Kenneth Smith, Modesto, CA (US)

(21) Appl. No.: 13/830,554

(22) Filed: Mar. 14, 2013

(51) Int. Cl. G06F 17/22; G06Q 30/02

(52) U.S. Cl. CPC G06F 17/2247; G06Q 30/0251
USPC 705/14.49; 715/235

(57) ABSTRACT

Disclosed is a method for directing an alternative cascading style sheet object to an internet user client. In the method, a system analyzes an HTTP transaction involving the internet user client to detect a request for an embedded cascading style sheet object. The system responds to the request for the embedded cascading style sheet object by forwarding the alternative cascading style sheet object to the internet user client.

### CROSS-REFERENCE TO RELATED APPLICATION

This application is related to U.S. application Ser. No. 12/546,812, filed Aug. 24, 2009, which application is incorporated herein by reference.

### BACKGROUND

1. Field

The present invention relates to the delivery and customization of Internet content to deliver specific communications to Internet users by their Internet Service Provider.

2. Background

Internet Service Providers (ISPs) provide many valuable services for consumers beyond transmitting packets of digital information. ISPs provide security, quality-of-service, privacy services, Internet filtering and other value-added services to their consumers.

Since the earliest days of the broad commercialization of the Internet in the mid 1990's, ISPs have primarily provided access to content provided by Internet Content Providers (ICPs) such as YAHOO and MICROSOFT. While providing the basic access to the web servers of ICPs, consumers expect uninterrupted service. When there is an interruption in the service, a condition of account delinquency between the ISP and its user, or the need for the ISP to receive acknowledgement of a piece of legal compliance notice, the cost and complexities of customer communication is high.

ISPs typically use postal mail, email and telephone to communicate with their subscribers. However each of these methods lack one or more of these benefits: inexpensive, fast delivery, and guarantee of delivery. Postal mail is expensive and, with the increase of paperless billing, is being used less by ISPs. Email is quite effective for those subscribers who utilize the ISP-provided email account or provide an alternate address to the ISP. However, the ISP may not know the primary email address of their subscribers due to the popularity and use of web-based email services provided by GOOGLE and YAHOO. Telephone service is more expensive than all the other methods and is not a cost-effective solution for the ISP.

ISPs may wish to communicate effectively with their subscribers for many reasons including: delinquent payments, violation of terms of use such as exceeding limits of time or volumes of transmission, violation of copyrights of digital media, or to promote products and services through advertisements. As these examples show, there is a wide variety of content types an ISP may want to deliver to their subscribers.

Various existing methods for the customization of Internet content to end users such as Britton, (U.S. Pat. No. 6,442,577) and Slemmer (U.S. Pat. No. 6,226,677) provide models for the customization. These patents represent the current models of Internet customization for delivering communication from the ISP to the subscriber. In these models, HTML content, such as web page files for use as full pages or elements within pages such as frames, iframes or windows, is modified or replaced by content customized for the subscriber. This has proven to be an effective model of communication in the past, but new methods are desired for the delivery of advanced models of communication described in the present invention.

The Slemmer patent provides the ISP with the capability of sending various sorts of Internet communication to the user by using page redirection from the original web page requested by a user to a replacement page which may be populated with whatever content that the ISP should choose to display. However, the methods of communication as detailed in the Slemmer patent have the potential to cause the disruption or delay of the requested Internet content. The Slemmer patent is based upon the use of a proxy which has since been proven in the industry to be insufficient in facilitating the increasing load of Internet traffic today.

The Britton patent provides the capability to an ISP to customize web pages to their users according to criteria located in the service request.

In addition, networking equipment provided by companies such as CISCO, JUNIPER and F5 NETWORKS perform content customization by the replacement or modification of web pages. With the proliferation of Internet browsers employed by users such as INTERNET EXPLORER, FIREFOX, SAFARI and CHROME, and the billions of web pages available today, there are an increasing number of conflicts between customization methodologies and the vast array of styles and methods of web page design.

Delivery of customized Internet communication requires a flexible format that does not obstruct the user's access to the Internet content requested. Prior methods have included modification of the original web page. In this model, during serving or transmission, the contents of a web page are modified through addition, deletion or modification of pre-existing content so as to customize the content for a user or group of users.

Additionally, modifying the HTML page can result in unintended consequences such as failure of the page to load correctly or excessive delay in loading the page. It is a requirement of services which insert messages to be able to guarantee transparency to the end user.

There is, therefore, a need for a method and apparatus which enables ISPs to more effectively communicate with their subscribers. The present invention provides the methods and apparatuses to meet these needs.

### SUMMARY

An aspect of the present invention may reside in a method for directing an alternative cascading style sheet object to an internet user client. In the method, a system analyzes an HTTP transaction involving the internet user client to detect a request for an embedded cascading style sheet object. The system responds to the request for the embedded cascading style sheet object by forwarding the alternative cascading style sheet object to the internet user client.

In more detailed aspects of the invention, the internet user client may be a subscribing user client. The system may be associated with a network service provider that is an internet service provider. The alternative cascading style sheet object may include a request for the originally requested embedded cascading style sheet object. The alternative cascading style sheet object may be selected by a network service provider. Alternatively, the alternative cascading style sheet object comprises a reference to the originally requested embedded cascading style sheet object, and a reference to an additional cascading style sheet object. The reference to an additional cascading style sheet object may be associated with targeted advertising web content.

In other more detailed aspects of the invention, the targeted advertising web content may be selected by an advertisement selection service. The advertisement selection service may select the targeted advertising web content based on at least one targeting parameter received from a network service provider. In addition, the advertisement selection service may select the targeted advertising web content based on a modification value rank. The reference to an additional cascading style sheet object may be selected in accordance with a URL inclusion field, or with a URL restriction field. More than one internet user client may be associated with a particular service-type value. The method may further include the system maintaining a database of internet user clients that includes a particular service-type value for each internet user client. The system may select the alternative cascading style sheet object in accordance with the user client's particular service-type value.

Customized content associated with the additional cascading style sheet object may be presented in a new window displayed over a window presenting unmodified content associated with the originally requested embedded cascading style sheet object. Also, customized content associated with the additional cascading style sheet object may be presented in a new window under a window presenting unmodified content associated with the originally requested embedded cascading style sheet object. In addition, customized content associated with the additional cascading style sheet object may be presented in a content region that flies over unmodified content associated with the originally requested embedded cascading style sheet object. Customized content associated with the additional cascading style sheet object may be presented in a semi-transparent content region over unmodified content associated with the originally requested embedded cascading style sheet object. The semi-transparent content region may fade into a fully opaque content region.

Another aspect of the invention may reside in an apparatus for directing an alternative cascading style sheet object to an internet user client, comprising: means for analyzing an HTTP transaction involving the internet user client to detect a request for an embedded cascading style sheet object; and means for responding to the request for the embedded cascading style sheet object by forwarding the alternative cascading style sheet object to the internet user client.

Another aspect of the invention may reside in a computer program product, comprising computer readable medium storing: code for causing a computer to analyze an HTTP transaction involving the internet user client to detect a request for an embedded cascading style sheet object; and code for causing a computer to respond to the request for the embedded cascading style sheet object by forwarding the alternative cascading style sheet object to the internet user client.

The present invention also may be embodied in an Internet traffic monitoring method that includes an ISP analyzing an HTTP transaction containing a Cascading Style Sheet (CSS) embedded CSS web object. CSS objects are used by web site developers to create a uniform design throughout a web site. The ISP responds to the embedded CSS object HTTP transaction by forwarding, to the Internet user client, a modified CSS object.

In more detailed aspects of the invention, the modified CSS object may include a reference to the original embedded CSS object plus a reference to an additional embedded CSS object.

In more detailed aspects of the invention, the HTTP transaction for an embedded object may include customized content for the subscriber that may be targeted according to the ISP's communication requirements. The ISP may create business rules for the notification of subscribers who meet specific criteria for communication.

In one embodiment of the present invention, the user may be delivered a specific communication when the registered payment credit card is nearing expiration, or the user's bill has become past due.

In yet another embodiment, if a subscriber has violated the terms of use or a law regulating Internet use, the present invention may be used to deliver a specific communication.

In another embodiment, the ISP or its partners may deliver a specific communication offering products or services to the subscriber.

In other more detailed aspects of the invention, the type of content to display may comprise redirections, frame insertions, interstitials, page modifications and other methods as allowed by W3C specifications and the extensive capabilities of web browsers.

In other more detailed aspects of the invention, an advertisement selection service may select targeted advertising web content for presentation by the Internet user client based on at least one targeting parameter from the ISP or a 3rd party partner of the ISP.

### BRIEF DESCRIPTION OF THE DRAWINGS

FIG. 1 depicts an exemplary network system, in which the present invention can function.

FIG. 2 depicts an exemplary HTTP transaction, in which content modification has been performed, according to the present invention.

FIG. 3 depicts an exemplary HTTP transaction without modifications.

FIG. 4 depicts an exemplary HTTP transaction with modifications according to the present invention.

FIG. 5 depicts a flowchart illustrating the process of detecting a user session and assigning a service plan, in accordance with the present invention.

FIG. 6 depicts a flowchart illustrating the process of analyzing an HTTP transaction and applying eligible content modification, in accordance with the present invention.

FIG. 7 depicts a flowchart illustrating the process of modifying an HTTP transaction, in accordance with the present invention.

FIG. 8 depicts an exemplary subscriber service database for the present invention.

FIG. 9 depicts an exemplary active session database for the present invention.

FIG. 10 depicts an exemplary service subscription database for the present invention.

FIG. 11 depicts an exemplary URL list database for the present invention.

FIG. 12 depicts an exemplary content modification database for the present invention.

FIG. 13 depicts an exemplary web page with top framed content modification in place.

FIG. 14 depicts an exemplary web page with bottom framed content modification in place.

FIG. 15 depicts an exemplary web page with left framed content modification in place.

FIG. 16 depicts an exemplary web page with right framed content modification in place.

FIGS. 17A-17D depict an exemplary web page with content modification in the form of a flyover message.

FIGS. 18A-18C depict an exemplary web page with content modification in the form of an intertoastal message.

FIGS. 19A and 19B depict an exemplary web page before and after a content modification has taken place.

FIGS. 20A-20C depict an exemplary web page with content modification in the form of a peel-over message

FIGS. 21A and 21B depict an exemplary web page with content modification in the form of an interstitial message.

FIGS. 22A and 22B depict an exemplary web page with content modification in the form of a redirect message.

FIG. 23 depicts a flowchart illustrating a method for directing an alternative CSS object to an internet user client, according to the present invention.

FIG. 24 depicts a computer including a processor and a memory

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

FIG. 1 depicts a diagram illustrating an exemplary network 100, which includes one or more Internet users connected to the Internet via ISPs. The web site traffic of these users is monitored by one or more advertising networks and one or more traffic measurement companies via the present invention.

As shown in FIG. 1, the network 100 includes users 111.1-112.N, one or more ISPs 120.1-120.2 (e.g., Network Service Providers (NSPs)), the Internet 130, an embedded object server 140, a web server 150, and one or more advertising networks 160.1-160.N. Each ISP may include a content modification server 122.1-122.N. Alternatively, the ISP may have prompt access to one or more content modification servers 170 by means of the internet.

FIG. 2 depicts a diagram illustrating an exemplary HTTP transaction 200 which is initiated by a client 205 and which is modified by a content modification server 210 in accordance with the present invention.

At step 220, the client makes an HTTP request for a page on a web server 215.

At step 225, the web server 215 sends an HTTP response for a page with an embedded CSS object to the client 205.

At step 230, the client makes an HTTP request for the embedded object(s) on the web server 215.

At step 235, the content modification server 210 sends a modified HTTP response to the client 205. At step 240, the web server 215 sends an HTTP response with the embedded

CSS object to the client 205. The client will ignore this response because it has already received a modified HTTP response from the content modification server 210.

At step 245, the client makes an HTTP request for a new embedded object as directed by the content modification server 210 in step 235.

At step 250, the content modification server 210 sends the HTTP response for the new embedded object to the client.

At step 255, the client makes an HTTP request for the original embedded object to the web server 215. The requested embedded CSS object is the object requested in step 230.

At step 260, the web server 215 sends an HTTP response for the original embedded object to the client.

FIG. 3 depicts an exemplary HTTP transaction without modifications 300 wherein a web browser executed the HTML for making a request to a web server for a CSS object 310 as in step 220 of FIG. 2. The web server returns an HTTP response containing CSS code 320 in order to execute the desired operation for the web object as in step 225 of FIG. 2.

FIG. 4 depicts an exemplary HTTP transaction with modifications according to the present invention 400 for inserting modifying web content by modifying the embedded CSS object's response as in step 235 of FIG. 2 and process 700, as shown in FIG. 7. A web request 410 is sent to the web server 150. The response from the web server is modified or replaced with a new response 420 by the content modification server 210 which contains CSS code to execute a desired operation for a new CSS object as well as a request for the original CSS object as in steps 245 and 255 of FIG. 2. As an example, the new response 420 may include a reference to a new CSS object, e.g., “message.css” 430. The object/file message.css may have CSS code/instructions for inserting the new content.

FIG. 5 depicts a flowchart illustrating the process 500 of detecting a user session and assigning a service plan, in accordance with the present invention. In describing FIG. 5, it is assumed that: 1) The Internet user is connected to the Internet through an ISP (as shown in FIG. 1) that utilizes the invention; and 2) requests web content from various web servers which contain references to embedded content (as shown in FIG. 1, 160.1-171).

In FIG. 5, the Internet user (which can be any one of the users shown in FIGS. 1, 111.1-112.N) first establishes an Internet connection through an ISP (as shown in FIGS. 1, 120.1 and 120.2). At step 510 the present invention detects a new user session from an Internet user (which can be using any one of the users 111.1-112.N).

At step 520, if a user ID is detected for the new user session, the user is sent to step 540 otherwise program flow is transferred to step 530.

At step 530, an application executed by the content modification server applies the default service type to the user and sends the user to step 570.

At step 540, the application checks field 810 in the database 800, shown in FIG. 8, to see if the user ID contains subscriber service settings.

At step 550, if the database does not contain references to the user ID referenced in step 540, then the user is sent to step 530. If the database does contain subscriber service settings, those settings are applied and the program proceeds to step 560.

At step 560, the application assigns the service type as directed for the user ID in field 820 in the database 800. The program flow proceeds to step 570.

At step 570, the application places the user's IP address and service settings in fields 910 and 920 respectively of the active session database 900. When the user information has been placed in the database 900, the program flow proceeds to step 580.

At step 580 the process terminates.

FIG. 6 depicts a flowchart illustrating the process 600 of analyzing an HTTP transaction and applying eligible content modification, in accordance with the present invention. In describing FIG. 6, it is assumed that: 1) The Internet user is connected to the Internet through an ISP (as shown in FIG. 1) that utilizes the invention; and 2) requests web content from various web servers which contain references to embedded content (as shown in FIG. 1, 160.1-171).

At step 605, the Internet user (which can be using any one of the users 111.1-112.N) initiates a new HTTP transaction by requesting web content as in step 220 of FIG. 2.

At step 610, an application executed by the content modification server correlates the source IP address in the HTTP request with the field 910 to see if the user's IP is in the active session database 900. If the user is not in an active session, the program flow proceeds to step 640. If the user is in an active session, the program flow proceeds to step 615.

At step 615, the application uses the service type from field 920 in the active session database 900 to retrieve eligible modifications from fields 1020.1-1020.N which apply for the selected service type in field 1010 of the service subscription database 1000. The program flow proceeds to step 620.

At step 620, application gets interval restrictions from field 1240 in the modification database 1200 for each of the eligible modification IDs in field 1210 of database 1200. URL inclusions and restrictions from fields 1220 and 1230 in database 1200, shown in FIG. 12, are retrieved from database 1100.

At step 625, if the elapsed time between relevant intervals and the time of last modification in field 930 of the active session database 900 does not permit the modification to be performed, or any of the URL restrictions apply, the program flow proceeds to step 630. Otherwise, the program flow proceeds to step 635.

At step 630, the eligible modifications list is updated to remove ineligible modifications. The program flow proceeds to step 635.

At step 635, if the user is eligible for one or more modification, the program flow proceeds to step 645. If the user is not eligible for any modification, the program flow proceeds to step 640.

At step 640, the process terminates.

At step 645, the application conducts the content modification routine 700, shown in FIG. 7, and the program flow proceeds to step 650.

At step 650, the process terminates.

FIG. 7 depicts a flowchart illustrating the process 700 of modifying an HTTP transaction, in accordance with the present invention.

At step 710, the content modification process is initiated through by step 645 as shown in FIG. 6.

At step 720, an application executed by the content modification server chooses the highest value modification in field 1250 of the modification database 1200, shown in FIG. 12, from the eligible modifications list passed from process 600. The program flow proceeds to step 730.

At step 730, the application creates a modified HTTP response from field 1260 of the modification database 1200.

At step 740, the modified HTTP response is sent to the user as in step 235 of FIG. 2.

At step 750, the application updates the last modification time in field 930 of the active session database 900, shown in FIG. 9, with the most recent modification timestamp.

At step 760, the process returns to step 645 in the process 600 of FIG. 6.

FIG. 8 depicts an exemplary subscriber service database 800 located at a ISP (or, alternatively, it can be located off-site on a separate network) (which can be any one of the ISPs 120.1-120.2) for storing user identification and service type information, in accordance with the present invention.

The subscriber service database 800 (which is on a computer system, such as an ISP, content modification device and/or web server, as shown in FIG. 1) has at least three fields: 1) a Subscriber or User field, 810, containing the username (some NSPs could use this field for the user's IP address, Media Access Control—MAC address, or Global Unique Identifier—GUID, instead of a username); 2) a Service Type field, 820, detailing which service type the user is subscribed to; and 3) a Location field, 830 containing the subscriber's location.

FIG. 9 depicts an exemplary active session database 900 located at a ISP (or, alternatively, it can be located off-site on a separate network) (which can be any one of the ISPs 120.1-120.2) for storing active session and last modification time information, in accordance with the present invention.

The active session database 900 (which is on a computer system, such as an ISP, content modification device and/or web server, as shown in FIG. 1) has at least three fields: 1) an IP address field, 910, containing the user's currently assigned IP address; 2) a Service Type field, 920, detailing which service type the user is subscribed to; and 3) a Last Modification field, 930 containing a timestamp of the last time a content modification was conducted for the user. In other embodiments multiple timestamps may be employed and the user may be characterized by multiple service types to allow more granular control over modifications.

FIG. 10 depicts an exemplary service subscription database 1000 located at an ISP (or, alternatively, it can be located off-site on a separate network) (which can be any one of the ISPs 120.1-120.2) for storing service type modification information, in accordance with the present invention.

The service subscription database 1000 (which is on a computer system, such as an ISP, content modification device and/or web server, as shown in FIG. 1) has at least two fields: 1) a Service Type field, 1010, containing the service type ID; and at least one 2) a Modification field, 1020, containing a logical value indicating whether or not the modification is applicable to the current service type.

FIG. 11 depicts an exemplary URL List database 1100 located at an ISP (or, alternatively, it can be located off-site on a separate network) (which can be any one of the ISPs 120.1-120.2) for storing URL restriction and inclusion information, in accordance with the present invention.

The URL list database 1100 (which is on a computer system, such as an ISP, content modification device and/or web server, as shown in FIG. 1) has at least two fields: 1) a URL ID field, 1110, containing the URL ID number; and 2) a URL field, 1120, containing a specific URL.

FIG. 12 depicts an exemplary modification database 1200 located at an ISP (or, alternatively, it can be located off-site on a separate network) (which can be any one of the ISPs 120.1-120.2) for storing content modification information, in accordance with the present invention.

The modification database 1200 (which is on a computer system, such as an ISP, content modification device and/or web server, as shown in FIG. 1) has at least six fields: 1) a Modification ID field, 1210, containing the modification ID number; 2) a URL Inclusion List field, 1220, which references URL IDs in the URL List database 1100 for which content modifications can be expressly made; 3) a URL Exclusion List field, 1230, which references URL IDs in the URL List database 1100 for which content modifications cannot be made; 4) a Minimum Time Since Last Modification field, 1240, which provides minimum time intervals in seconds which must have elapsed before another content modification can be made; 5) a Value field, 1250, which ranks modifications according to monetary and utility value; and 6) a URL of Modification Style field, 1260, which contains the network location of the modification style.

FIG. 13 depicts an exemplary web page or portion thereof 1300 after the content modification routine (700) has completed. The original content requested in step 605 (FIG. 6) is represented in frame 1310. The customized content which is returned in step 250 (FIG. 2) is displayed in frame 1320. In this embodiment of the content modification the customized content is displayed in a new frame at the top of the originally requested page.

FIG. 14 depicts an exemplary web page or portion thereof 1400 after the content modification routine (700) has completed. The original content requested in step 605 (FIG. 6) is represented in frame 1410. The customized content which is returned in step 250 (FIG. 2) is displayed in frame 1420. In this embodiment of the content modification the customized content is displayed in a new frame at the bottom of the originally requested page.

FIG. 15 depicts an exemplary web page or portion thereof 1500 after the content modification routine (700) has completed. The original content requested in step 605 (FIG. 6) is represented in frame 1510. The customized content which is returned in step 250 (FIG. 2) is displayed in frame 1520. In this embodiment of the content modification the customized content is displayed in a new frame at the left side of the originally requested page.

FIG. 16 depicts an exemplary web page or portion thereof 1600 after the content modification routine (700) has completed. The original content requested in step 605 (FIG. 6) is represented in frame 1610. The customized content which is returned in step 250 (FIG. 2) is displayed in frame 1620. In this embodiment of the content modification the customized content is displayed in a new frame at the right side of the originally requested page.

FIGS. 17A-17D depict an exemplary web page or portion thereof 1700 after the content modification routine (700) has completed. The original content requested in step 605 (FIG. 6) is represented in content region 1710. The customized content which is returned in step 250 (FIG. 2) is displayed in the new content region 1720. In this embodiment of the content modification the customized content is displayed in a new content region which enters the window in FIG. 17A, flies over the originally requested content in FIG. 17B and FIG. 17C, and exits the window in FIG. 17D along a predetermined path.

FIG. 18A depicts an exemplary web page or portion thereof 1800 after the content modification routine (700) has completed. The original content requested in step 605 (FIG. 6) is represented in frame 1810. In FIG. 18B the customized content which is returned in step 250 (FIG. 2) is displayed in the new content region 1820. In FIG. 20C the customized content in content region 1820 scrolls over the originally requested content to a final position as seen in FIG. 18C. In this embodiment of the content modification the customized content is displayed in a new content region which enters the window in FIG. 18B, and scrolls in over the originally requested content to a predetermined position as seen in FIG. 18C. The scrolling animation depicted in FIG. 18B and FIG. 18C can be configured to originate from multiple positions at different speeds and along multiple paths. In addition, the content region may be configured with additional behaviors which are characteristic of existing capabilities of web content.

FIG. 19A depicts an exemplary web page or portion thereof 1900 before the content modification routine (700) has completed. The original content requested in step 605 (FIG. 6) is represented in FIG. 19A in frames 1910, 1920, and 1930. FIG. 19B depicts the exemplary web page 1900 after the content modification routine (700) has completed. The customized content which is returned in step 250 (FIG. 2) is displayed in the frames 1920 and 1930, while the original content in frame 1910 remains unmodified.

FIG. 20A depicts an exemplary web page or portion thereof 2000 after the content modification routine (700) has completed. The original content requested in step 605 (FIG. 6) is represented in frame 2010. In FIG. 20B the customized content which is returned in step 250 (FIG. 2) is displayed in the new, semi-transparent content region 2020. In FIG. 20C the customized content in frame 2020 is fully opaque. In this embodiment of the content modification the customized content is displayed in a new content region which enters the window in FIG. 20B, and fades in over the originally requested content at a predetermined position as seen in FIG. 20C. The fading animation depicted in FIG. 20B and FIG. 20C can be configured to occur at multiple positions and speeds. In addition, the content region may be configured with additional behaviors which are characteristic of existing capabilities of web content.

FIG. 21A depicts an exemplary web page or portion thereof 2100 which contains unmodified web content in 2110. FIG. 21B depicts an exemplary web page or portion thereof after the content modification routine (700) has completed. The customized content which is returned in step 250 (FIG. 2) is displayed in frame 2120. A hyperlink to original content requested in step 605 (FIG. 6) is represented in frame 2130. In this embodiment of the content modification the customized content is displayed in the form of an interstitial web page such that the customized content is displayed in a full page format before the originally requested content is delivered to the user. In addition, the frame may be configured with additional behaviors which are characteristic of existing capabilities of web content.

FIG. 22A depicts an exemplary web page or portion thereof 2200 which contains unmodified web content in 2210. FIG. 22B depicts an exemplary web page or portion thereof after the content modification routine (700) has completed. The customized content which is returned in step 250 (FIG. 2) is displayed in frame 2220. In this embodiment of the content modification the customized content is displayed in the form of an redirected web page such that the customized content is displayed in a full page format; when the original content requested in step 605 (FIG. 6) arrives, it is ignored by the client.

With further reference to FIG. 23, an aspect of the present invention may reside in a method 2300 for directing an alternative cascading style sheet object 430 to an internet user client 111. In the method, a system (e.g., NSP 120 and/or content modification server 122 and/or 170) analyzes an HTTP transaction involving the internet user client to detect a request 410 for an embedded cascading style sheet object 440 (step 2310). The system responds to the request for the embedded cascading style sheet object by forwarding the alternative cascading style sheet object to the internet user client (step 2320).

In more detailed aspects of the invention, the internet user client may be a subscribing user client. The system may be associated with a network service provider that is an internet service provider. The alternative cascading style sheet object may include a request for the originally requested embedded cascading style sheet object. The alternative cascading style sheet object may be selected by a network service provider. Alternatively, the alternative cascading style sheet object comprises a reference to the originally requested embedded cascading style sheet object, and a reference to an additional cascading style sheet object. The reference to an additional cascading style sheet object may be associated with targeted advertising web content.

In other more detailed aspects of the invention, the targeted advertising web content may be selected by an advertisement selection service. The advertisement selection service may select the targeted advertising web content based on at least one targeting parameter received from a network service provider. In addition, the advertisement selection service may select the targeted advertising web content based on a modification value rank. The reference to an additional cascading style sheet object may be selected in accordance with a URL inclusion field, or with a URL restriction field. More than one internet user client may be associated with a particular service-type value. The method may further include the system maintaining a database of internet user clients that includes a particular service-type value for each internet user client. The system may select the alternative cascading style sheet object in accordance with the user client's particular service-type value.

Customized content associated with the additional cascading style sheet object may be presented in a new window displayed over a window presenting unmodified content associated with the originally requested embedded cascading style sheet object. Also, customized content associated with the additional cascading style sheet object may be presented in a new window under a window presenting unmodified content associated with the originally requested embedded cascading style sheet object. In addition, customized content associated with the additional cascading style sheet object may be presented in a content region that flies over unmodified content associated with the originally requested embedded cascading style sheet object. Customized content associated with the additional cascading style sheet object may be presented in a semi-transparent content region over unmodified content associated with the originally requested embedded cascading style sheet object. The semi-transparent content region may fade into a fully opaque content region.

As shown in FIG. 24, the ISPs and/or the content modification server(s) (or other servers) each may comprise a computer 2400 that may include a processor 2410, a storage medium 2420 such as memory and/or a disk drive, a display 2430, and an input such as a keypad 2440, and a wireless connection 2450.

Another aspect of the invention may reside in an apparatus for directing an alternative cascading style sheet object 430 to an internet user client 111, comprising: means 2410 for analyzing an HTTP transaction involving the internet user client to detect a request 410 for an embedded cascading style sheet object 440; and means 2410 for responding to the request for the embedded cascading style sheet object by forwarding the alternative cascading style sheet object to the internet user client.

Another aspect of the invention may reside in a computer program product, comprising computer readable medium 2420 storing: code for causing a computer 2400 to analyze an HTTP transaction involving the internet user client 111 to detect a request 410 for an embedded cascading style sheet object 440; and code for causing a computer to respond to the request for the embedded cascading style sheet object by forwarding the alternative cascading style sheet object 430 to the internet user client.

Additionally, the present invention may be embodied in a method for directing network service provider selected embedded objects to an internet user client. In the method, a network service provider maintains a database of internet user clients that includes a particular service-type value for each internet user client. The network service provider analyzes an HTTP transaction involving the internet user client. The network service provider responds to an HTTP transaction requesting an embedded CSS object by forwarding to the internet user client, an alternative embedded CSS object selected in accordance with the user client's particular service-type value, wherein the alternative embedded CSS object arrives to the internet user client before a response to the originally requested embedded CSS object. The network service provider causes the originally requested embedded CSS object to be forwarded to the internet user client after the alternative embedded CSS object is forwarded to the internet user client.

In more detailed features of the invention, the network service provider may be an internet service provider, and the internet user client may be a subscribing user client. The alternative embedded CSS object may include a request for the originally requested embedded CSS object. The originally requested object may be a CSS object, and the alternative object may be a CSS object that includes a request for a CSS object of the originally requested embedded CSS object. The alternative embedded CSS object may be selected by the network service provider. The alternative embedded CSS object may comprise a reference to the originally requested embedded CSS object, and a reference to an additional embedded CSS object. The reference to an additional embedded CSS object may be associated with targeted advertising web content. The targeted advertising web content may be selected by an advertisement selection service. The advertisement selection service may select the targeted advertising web content based on at least one targeting parameter received from the network service provider. The advertisement selection service may select the targeted advertising web content based on a modification value rank. The reference to an additional embedded CSS object may be selected in accordance with a URL inclusion field and/or with a URL restriction field. Also, more than one internet user client may be associated with a particular service-type value.

In more detailed features of the invention, there may be a plurality of web servers that provide the elements of a single web page. In such an embodiment, the html, css, and other elements such as scripts, images and videos may be delivered from a variety of web servers, content delivery networks or 3rd parties such as advertising networks. Furthermore, there may be multiple CSS resources delivered each from a variety of servers.

In other more detailed features of the invention, customized content associated with the additional embedded CSS object may be presented in a first frame, and unmodified content associated with the originally requested embedded CSS object may be presented in a second frame. Alternatively, a link to customized content associated with the additional embedded CSS object may be presented in the first frame. The customized content may be presented in a new window displayed over a window presenting the unmodified content. The customized content may be presented in a new window under a window presenting the unmodified content associated with the originally requested embedded CSS object. The customized content may be presented in a content region that flies over the unmodified content. The customized content may be presented in a semi-transparent content region over the unmodified content. The semi-transparent content region may fade into a fully opaque content region.

The present invention also may be embodied in an apparatus for directing network service provider selected embedded objects to an internet user client. The apparatus may include means for maintaining a database of internet user clients that includes a particular service-type value for each the internet user client, means for analyzing an HTTP transaction involving the internet user client, means for responding to an HTTP transaction requesting an embedded object by forwarding to the internet user client, an alternative embedded CSS object selected by a network service provider, wherein the alternative embedded CSS object arrives to the internet user client before a response to the originally requested web object, and means for causing the originally requested web object to be forwarded to the internet user client after the alternative embedded CSS object is forwarded to the internet user client.

Further, the present invention may be embodied in a computer program product comprising computer readable medium storing: code for causing a computer to maintain a database of a network service provider's internet user clients that includes a particular service-type value for each the internet user client, code for causing a computer to analyze an HTTP transaction involving the internet user client, code for causing a computer to respond to an HTTP transaction requesting an embedded object by forwarding to the internet user client, an alternative embedded CSS object selected by a network service provider, wherein the alternative embedded CSS object arrives to the internet user client before a response to the originally requested web object, and code for causing a computer to forward the originally requested web object to the internet user client after the alternative embedded CSS object is forwarded to the internet user client.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for directing an alternative cascading style sheet object to an internet user client, comprising:
a system analyzing an HTTP transaction involving the internet user client to detect a request for an embedded cascading style sheet object; and
the system responding to the request for the embedded cascading style sheet object by forwarding the alternative cascading style sheet object to the internet user client.

2. A method for directing an alternative cascading style sheet object as defined in claim 1, wherein the internet user client is a subscribing user client.

3. A method for directing an alternative cascading style sheet object as defined in claim 1, wherein the system is associated with a network service provider that is an internet service provider.

4. A method for directing an alternative cascading style sheet object as defined in claim 1, wherein the alternative cascading style sheet object includes a request for the originally requested embedded cascading style sheet object.

5. A method for directing an alternative cascading style sheet object as defined in claim 1, wherein the alternative cascading style sheet object is selected by a network service provider.

6. A method for directing an alternative cascading style sheet object as defined in claim 1, wherein the alternative cascading style sheet object comprises a reference to the originally requested embedded cascading style sheet object, and a reference to an additional cascading style sheet object.

7. A method for directing a selected cascading style sheet object as defined in claim 6, wherein the reference to an additional cascading style sheet object is associated with targeted advertising web content.

8. A method for directing an alternative cascading style sheet object as defined in claim 7, wherein the targeted advertising web content is selected by an advertisement selection service.

9. A method for directing an alternative cascading style sheet object as defined in claim 8, wherein the advertisement selection service selects the targeted advertising web content based on at least one targeting parameter received from a network service provider.

10. A method for directing an alternative cascading style sheet object as defined in claim 8, wherein the advertisement selection service selects the targeted advertising web content based on a modification value rank.

11. A method for directing an alternative cascading style sheet object as defined in claim 6, wherein the reference to an additional cascading style sheet object is selected in accordance with a URL inclusion field.

12. A method for directing an alternative cascading style sheet object as defined in claim 6, wherein the reference to an additional cascading style sheet object is selected in accordance with a URL restriction field.

13. A method for directing an alternative cascading style sheet object as defined in claim 6, wherein customized content associated with the additional cascading style sheet object is presented in a new window displayed over a window presenting unmodified content associated with the originally requested embedded cascading style sheet object.

14. A method for directing an alternative cascading style sheet object as defined in claim 6, wherein customized content associated with the additional cascading style sheet object is presented in a new window under a window presenting unmodified content associated with the originally requested embedded cascading style sheet object.

15. A method for directing an alternative cascading style sheet object as defined in claim 6, wherein customized content associated with the additional cascading style sheet object is presented in a content region that flies over unmodified content associated with the originally requested embedded cascading style sheet object.

16. A method for directing an alternative cascading style sheet object as defined in claim 6, wherein customized content associated with the additional cascading style sheet object is presented in a semi-transparent content region over unmodified content associated with the originally requested embedded cascading style sheet object.

17. A method for directing an alternative cascading style sheet object as defined in claim 16, wherein the semi-transparent content region fades into a fully opaque content region.

18. A method for directing an alternative cascading style sheet object as defined in claim 1, wherein more than one internet user client is associated with a particular service-type value.

19. A method for directing an alternative cascading style sheet object as defined in claim 1, further comprising:
the system maintaining a database of internet user clients that includes a particular service-type value for each internet user client; and
the system selecting the alternative cascading style sheet object in accordance with the user client's particular service-type value.

20. An apparatus for directing an alternative cascading style sheet object to an internet user client, comprising:
means for analyzing an HTTP transaction involving the internet user client to detect a request for an embedded cascading style sheet object; and
means for responding to the request for the embedded cascading style sheet object by forwarding the alternative cascading style sheet object to the internet user client.

21. An apparatus for directing an alternative cascading style sheet object as defined in claim 20, wherein the internet user client is a subscribing user client.

22. An apparatus for directing an alternative cascading style sheet object as defined in claim 20, wherein the apparatus is associated with a network service provider that is an internet service provider.

23. An apparatus for directing an alternative cascading style sheet object as defined in claim 20, wherein the alternative cascading style sheet object includes a request for the originally requested embedded cascading style sheet object.

24. An apparatus for directing an alternative cascading style sheet object as defined in claim 20, wherein the alternative cascading style sheet object comprises a reference to the originally requested embedded cascading style sheet object, and a reference to an additional cascading style sheet web object.

25. An apparatus for directing an alternative cascading style sheet object as defined in claim 24, wherein the reference to an additional cascading style sheet object is associated with targeted advertising web content.

26. An apparatus for directing an alternative cascading style sheet object as defined in claim 25, wherein the targeted advertising web content is selected based on a modification value rank.

27. An apparatus for directing an alternative cascading style sheet object as defined in claim 20, wherein more than one internet user client is associated with a particular service-type value.

28. An apparatus for directing an alternative cascading style sheet object as defined in claim 20, further comprising:
means for maintaining a database of internet user clients that includes a particular service-type value for each internet user client; and
means for selecting the alternative cascading style sheet object in accordance with the user client's particular service-type value.

29. A computer program product, comprising:
computer-readable medium storing:
code for causing a computer to analyze an HTTP transaction involving a internet user client to detect a request for an embedded cascading style sheet object; and
code for causing a computer to respond to the request for the embedded cascading style sheet object by forwarding an alternative cascading style sheet object to the internet user client.

30. A computer program product as defined in claim 29, wherein the alternative cascading style sheet object includes a request for the originally requested embedded cascading style sheet object.

31. A computer program product as defined in claim 29, wherein the alternative cascading style sheet object comprises a reference to the originally requested embedded cascading style sheet object, and a reference to an additional cascading style sheet object.

32. A computer program product as defined in claim 31, wherein the reference to an additional cascading style sheet object is associated with targeted advertising web content.

33. A computer program product as defined in claim 32, wherein the targeted advertising web content is selected based on a modification value rank.

34. A computer program product as defined in claim 29, wherein more than one internet user client is associated with a particular service-type value.

35. A computer program product as defined in claim 29, wherein the computer readable medium further comprises:
code for causing a computer to maintain a database of internet user clients that includes a particular service-type value for each internet user client; and
code for causing a computer to select the alternative cascading style sheet object in accordance with the user client's particular service-type value.
